(19) United States
(12) Patent Application Publication
(10) Pub. No.: US 2026/0302338 A1
(43) Pub. Date: Oct. 1, 2026

(54) SOLID ELECTROLYTE LAYER, ELECTROCHEMICAL CELL, ELECTROCHEMICAL CELL DEVICE, MODULE, AND MODULE HOUSING DEVICE

(71) Applicant: KYOCERA Corporation, Kyoto-shi, Kyoto (JP)

(72) Inventor: Kazunari MIYAZAKI, Kirishima-shi, Kagoshima (JP)

(21) Appl. No.: 19/476,945

(22) PCT Filed: Apr. 26, 2024
(86) PCT No.: PCT/JP2024/016584

§ 371 Date: Oct. 20, 2025

(30) Foreign Application Priority Data
Apr. 27, 2023 (JP) 2023-073638

(51) Int. Cl. H01M 10/0562; H01M 50/204

(52) U.S. Cl. CPC H01M 10/0562; H01M 50/204; H01M 2300/0071

(57) ABSTRACT

A solid electrolyte layer includes a plurality of electrolytic particles including an oxide. The plurality of electrolytic particles include first particles and second particles. The first particles have a particle diameter of 1/10 or more of an average thickness of the solid electrolyte layer. The second particles have a particle diameter smaller than that of the first particles.

### TECHNICAL FIELD

The present disclosure relates to a solid electrolyte layer, an electrochemical cell, an electrochemical cell device, a module, and a module housing device.

### BACKGROUND OF INVENTION

In recent years, various fuel cell stack devices each including a plurality of fuel cells have been proposed, as next-generation energy. A fuel cell is a type of electrochemical cell capable of obtaining electrical power by using a fuel gas such as a hydrogen-containing gas and an oxygen-containing gas such as air.

### CITATION LIST

### Patent Literature

Patent Document 1: JP 2001-351647 A

Patent Document 2: JP 2003-317738 A

### SUMMARY

A solid electrolyte layer according to an aspect of an embodiment includes a plurality of electrolytic particles containing an oxide. The plurality of electrolytic particles include first particles and second particles. The first particles have a particle diameter of 1/10 or more of the average thickness of the solid electrolyte layer. The second particles have a particle diameter smaller than that of the first particles.

An electrochemical cell of the present disclosure includes the above-described solid electrolyte layer.

An electrochemical cell device according to the present disclosure includes a cell stack including the electrochemical cell described above.

A module of the present disclosure includes the electrochemical cell device described above and a storage container that houses the electrochemical cell device.

A module housing device of the present disclosure includes the module described above, an auxiliary device for operating the module, and an external case for housing the module and the auxiliary device.

### BRIEF DESCRIPTION OF THE DRAWINGS

FIG. 1A is a horizontal cross-sectional view illustrating an example of an electrochemical cell according to a first embodiment.

FIG. 1B is a side view of an example of the electrochemical cell according to the first embodiment when viewed from the side of an air electrode.

FIG. 1C is a side view of an example of the electrochemical cell according to the first embodiment when viewed from the side of an interconnector.

FIG. 2A is a perspective view illustrating an example of an electrochemical cell device according to the first embodiment.

FIG. 2B is a cross-sectional view taken along a line X-X illustrated in FIG. 2A.

FIG. 2C is a top view illustrating an example of the electrochemical cell device according to the first embodiment.

FIG. 3 is an enlarged cross-sectional view of a region R1 indicated in FIG. 1A.

FIG. 4 is an exterior perspective view illustrating an example of a module according to the first embodiment.

FIG. 5 is an exploded perspective view schematically illustrating an example of a module housing device according to the first embodiment.

FIG. 6A is a cross-sectional view illustrating an example of an electrochemical cell device according to a second embodiment.

FIG. 6B is a horizontal cross-sectional view illustrating an example of an electrochemical cell according to the second embodiment.

FIG. 7 is an enlarged cross-sectional view of a region R2 indicated in FIG. 6B.

FIG. 8 is a perspective view illustrating an example of an electrochemical cell according to a third embodiment.

FIG. 9 is a partial cross-sectional view illustrating an example of the electrochemical cell illustrated in FIG. 8.

FIG. 10 is an enlarged cross-sectional view of a region R3 indicated in FIG. 9.

FIG. 11A is a horizontal cross-sectional view illustrating an example of an electrochemical cell according to a fourth embodiment.

FIG. 11B is a horizontal cross-sectional view illustrating another example of the electrochemical cell according to the fourth embodiment.

FIG. 11C is a horizontal cross-sectional view illustrating a further example of the electrochemical cell according to the fourth embodiment.

FIG. 12 is an enlarged cross-sectional view of a region R4 indicated in FIG. 11A.

FIG. 13 is a diagram illustrating evaluation results of Samples Nos. 1 to 4.

FIG. 14 is a diagram illustrating evaluation results of Samples Nos. 5 to 8.

### DESCRIPTION OF EMBODIMENTS

The fuel cell stack device mentioned above has room for improvement in terms of increasing a performance thereof.

It is desired to provide a solid electrolyte layer, an electrochemical cell, an electrochemical cell device, a module, and a module housing device, which can have improved performance.

Embodiments of a solid electrolyte layer, an electrochemical cell, an electrochemical cell device, a module, and a module housing device disclosed in the present application will now be described in detail with reference to the accompanying drawings. Note that the disclosure is not limited by the following embodiments.

Note that the drawings are schematic and that the dimensional relationships between elements, the proportions of the elements, and the like may differ from the actual ones. There may be differences between the drawings in the dimensional relationships, proportions, and the like.

### First Embodiment

### Configuration of Electrochemical Cell

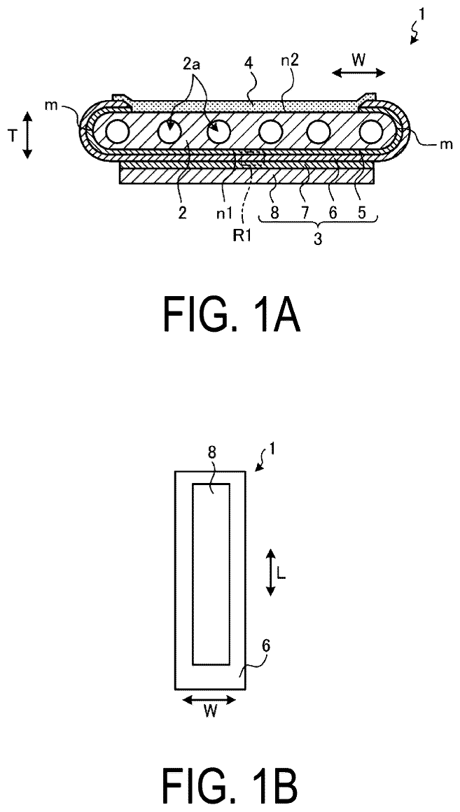

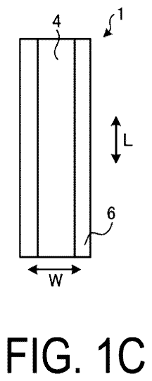

First, with reference to FIGS. 1A to 1C, an example of a solid oxide-type fuel cell will be described as an electrochemical cell according to a first embodiment. The electrochemical cell device may include a cell stack including a plurality of electrochemical cells. The electrochemical cell device including the plurality of electrochemical cells is simply referred to as a cell stack device.

FIG. 1A is a horizontal cross-sectional view illustrating an example of an electrochemical cell according to a first embodiment. FIG. 1B is a side view of an example of the electrochemical cell according to the first embodiment when viewed from the side of an air electrode. FIG. 1C is a side view of an example of the electrochemical cell according to the first embodiment when viewed from the side of an interconnector. Note that FIGS. 1A to 1C are enlarged views each illustrating part of a configuration of the electrochemical cell. Hereinafter, the electrochemical cell may be simply referred to as a cell.

In the example illustrated in FIGS. 1A to 1C, a cell 1 is of a hollow flat plate type, and has an elongated plate shape. As illustrated in FIG. 1B, the overall shape of the cell 1 when viewed from the side may be, for example, a rectangle having a side length of from 5 cm to 50 cm in a length direction L and a length of from 1 cm to 10 cm in a width direction W orthogonal to the length direction L. The thickness in a thickness direction T of the entire cell 1 may be, for example, from 1 mm to 5 mm.

As illustrated in FIG. 1A, the cell 1 includes a support substrate 2 with electrical conductivity, an element portion 3, and an interconnector 4. The support substrate 2 has a pillar shape including a first flat surface n1 and a second flat surface n2, which are a pair of flat surfaces facing each other, and a pair of circular arc-shaped side surfaces m that connect the first flat surface n1 and the second flat surface n2.

The element portion 3 is located on the first flat surface n1 of the support substrate 2. The element portion 3 includes a fuel electrode 5 serving as a first electrode, a solid electrolyte layer 6, an intermediate layer 7, and an air electrode 8 serving as a second electrode.

As illustrated in FIG. 1B, the air electrode 8 does not extend to the lower end of the cell 1. At a lower end portion of the cell 1, only the solid electrolyte layer 6 is exposed on a surface of the first flat surface n1. As illustrated in FIG. 1C, the interconnector 4 may extend to the lower end of the cell 1. At the lower end portion of the cell 1, the interconnector 4 and the solid electrolyte layer 6 are exposed on the surface. Note that, as illustrated in FIG. 1A, on the surface of the pair of the circular arc-shaped side surfaces m of the cell 1, the solid electrolyte layer 6 is exposed. The interconnector 4 need not extend to the lower end of the cell 1.

Hereinafter, each of the members constituting the cell 1 will be described.

The support substrate 2 includes gas-flow passages 2a, inside which gas flows. The example of the support substrate 2 illustrated in FIG. 1A includes six gas-flow passages 2a. The support substrate 2 has gas permeability and allows the fuel gas flowing through the gas-flow passages 2a to pass through to the fuel electrode 5. The support substrate 2 may have electrical conductivity. The support substrate 2 having electrical conductivity collects electricity generated in the element portion 3 to the interconnector 4.

The material of the support substrate 2 includes, for example, an iron group metal component and an inorganic oxide. For example, the iron group metal component may be Ni (nickel) and/or NiO. The inorganic oxide may be, for example, a specific rare earth element oxide. The rare earth element oxide may contain, for example, one or more rare earth elements selected from Sc, Y, La, Nd, Sm, Gd, Dy, and Yb.

As the material of the fuel electrode 5, a commonly known material may be used. As the fuel electrode 5, any of porous electrically conductive ceramics, such as ceramics containing ZrO₂ in which a calcium oxide, a magnesium oxide, or a rare earth element oxide is in solid solution, and Ni and/or NiO may be used. This rare earth element oxide may contain a plurality of rare earth elements, for example, selected from the group consisting of Sc, Y, La, Nd, Sm, Gd, Dy, and Yb. Hereinafter, ZrO₂ in which a calcium oxide, a magnesium oxide, or a rare earth element oxide is in solid solution may be referred to as stabilized zirconia. Stabilized zirconia may also include partially stabilized zirconia.

The solid electrolyte layer 6 is an electrolyte and delivers ions between the fuel electrode 5 and the air electrode 8. At the same time, the solid electrolyte layer 6 has gas blocking properties, and makes a leakage of the fuel gas and the oxygen-containing gas less likely to occur.

The material of the solid electrolyte layer 6 may be, for example, ZrO₂ in which 3 mole % to 15 mole % of rare earth element oxide is in solid solution. The rare earth element oxide may contain one or more rare earth elements, for example, selected from the group consisting of Sc, Y, La, Nd, Sm, Gd, Dy, and Yb. The solid electrolyte layer 6 may contain, for example, ZrO₂ in which Y, Yb, Sc, or Gd is in solid solution, or may contain BaZrO₃ in which Sc, Y, or Yb is in solid solution. Details of the solid electrolyte layer 6 will be described below.

The intermediate layer 7 functions as a diffusion prevention layer. The intermediate layer 7 makes strontium (Sr) contained in the air electrode 8, which will be described later, less likely to diffuse into the solid electrolyte layer 6, thereby making an electrical resistance layer of SrZrO₃ less likely to be formed on the solid electrolyte layer 6.

The material of the intermediate layer 7 is not particularly limited as long as the material is not likely to cause the diffusion of elements between the air electrode 8 and the solid electrolyte layer 6 in general. The material of the intermediate layer 7 may contain, for example, cerium oxide (CeO₂) in which rare earth elements other than cerium (Ce) are in solid solution. As such rare earth elements, gadolinium (Gd), samarium (Sm), or the like may be used.

The air electrode 8 has gas permeability. The open porosity of the air electrode 8 may be, for example, 20% or more, and particularly may be in a range from 30% to 50%.

The material of the air electrode 8 is not particularly limited, as long as the material is one generally used for the air electrode. The material of the air electrode 8 may be, for example, an electrically conductive ceramic such as a so-called ABO₃ type perovskite oxide.

The material of the air electrode 8 may be, for example, a composite oxide in which strontium (Sr) and lanthanum (La) coexist at the A site. Examples of such a composite oxide include LaₓSr₁₋ₓCo_{y}Fe_{1-y}O₃, LaₓSr₁₋ₓMnO₃, LaₓSr₁₋ₓFeO₃, and LaₓSr₁₋ₓCoO₃. Here, x is 0<x<1, and y is 0<y<1.

The interconnector 4 is dense, and makes, less likely to occur, the leakage of the fuel gas flowing through the gas-flow passages 2a located inside the support substrate 2, and of the oxygen-containing gas flowing outside the support substrate 2. The interconnector 4 may have a relative density of 93% or more, particularly 95% or more.

As the material of the interconnector 4, a lanthanum chromite-based perovskite-type oxide (LaCrO₃-based oxide), a lanthanum strontium titanium-based perovskite-type oxide ((La, Sr)TiO₃-based oxide), or the like may be used. These materials have electrical conductivity, and are unlikely to be reduced and also unlikely to be oxidized even when brought into contact with a fuel gas such as a hydrogen-containing gas and an oxygen-containing gas such as air.

### Configuration of Electrochemical Cell Device

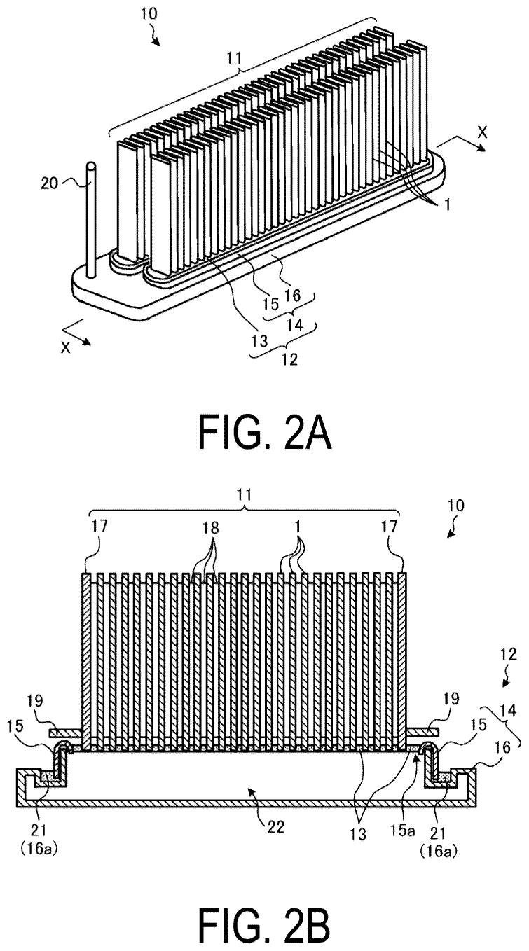

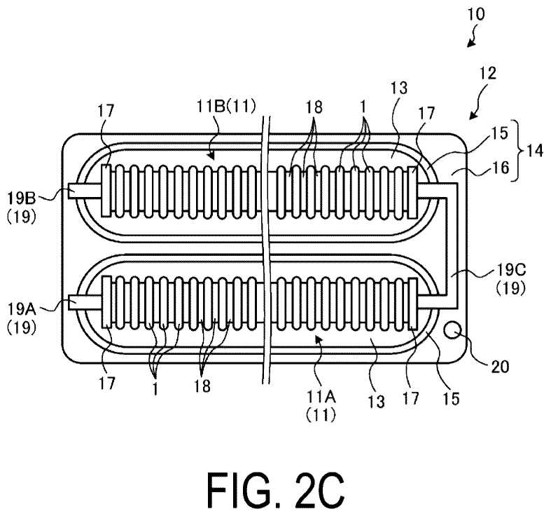

An electrochemical cell device according to the present embodiment using the cell 1 described above will be described with reference to FIGS. 2A to 2C. FIG. 2A is a perspective view illustrating an example of an electrochemical cell device according to the first embodiment. FIG. 2B is a cross-sectional view taken along a line X-X illustrated in FIG. 2A. FIG. 2C is a top view illustrating an example of the electrochemical cell device according to the first embodiment.

As illustrated in FIG. 2A, the cell stack device 10 includes a cell stack 11 including a plurality of the cells 1 arrayed (stacked) in the thickness direction T of each cell 1, and a fixing member 12 (see FIG. 1A).

The fixing member 12 includes a fixing material 13 and a support member 14. The support member 14 supports the cells 1. The fixing material 13 fixes the cells 1 to the support member 14. The support member 14 includes a support body 15 and a gas tank 16. The support body 15 and the gas tank 16, which constitute the support member 14, are, for example, made of metal.

As illustrated in FIG. 2B, the support body 15 includes an insertion hole 15a into which the lower end portions of the plurality of cells 1 are inserted. The lower end portions of the plurality of cells 1 and the inner wall of the insertion hole 15a are bonded with the fixing material 13.

The gas tank 16 includes an opening portion through which a reactive gas is supplied to the plurality of cells 1 via the insertion hole 15a, and a recessed groove 16a located on the periphery of the opening portion. The outer peripheral end portion of the support body 15 is bonded to the gas tank 16 by a bonding material 21 with which the recessed groove 16a of the gas tank 16 is filled.

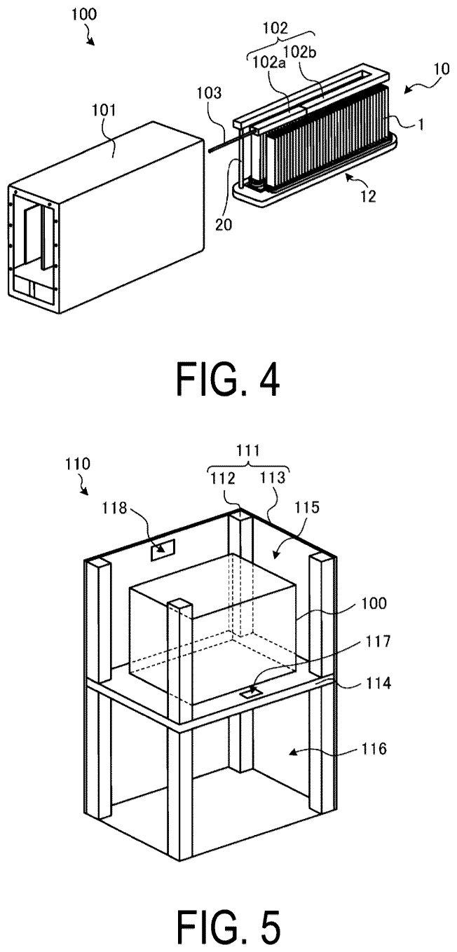

In the example illustrated in FIG. 2A, the fuel gas is stored in an internal space 22 (see FIG. 2B) formed by the support body 15 and the gas tank 16, constituting the support member 14. The gas tank 16 includes a gas circulation pipe 20 connected thereto. The fuel gas is supplied to the gas tank 16 through the gas circulation pipe 20 and is supplied from the gas tank 16 to the gas-flow passages 2a (see FIG. 1A) inside the cells 1. The fuel gas to be supplied to the gas tank 16 is produced in a reformer 102 (see FIG. 4) which will be described later.

A hydrogen-rich fuel gas can be produced, for example, by steam-reforming a raw fuel. When the fuel gas is produced by steam-reforming, the fuel gas contains steam.

In the example illustrated in FIG. 2A, two rows of the cell stacks 11, two support bodies 15, and the gas tank 16 are provided. Each of the two rows of the cell stacks 11 includes the plurality of cells 1. Each of the cell stacks 11 is fixed to a corresponding one of the support bodies 15. An upper surface of the gas tank 16 includes two through holes. Each of the support bodies 15 is disposed in a corresponding one of the through holes. The internal space 22 is constituted by a single gas tank 16 and two support bodies 15.

The insertion hole 15a has, for example, an oval shape in a top surface view. In the insertion hole 15a, for example, the length in the arrangement direction, that is, a thickness direction T of the cell 1 is larger than the distance between two end current collection members 17 located at both ends of the cell stack 11. The width of the insertion hole 15a is, for example, greater than the length of the cell 1 in the width direction W (see FIG. 1A).

As illustrated in FIG. 2B, the joined portions between the inner wall of the insertion hole 15a and the lower end portions of the cells 1 are filled with the fixing material 13, which is solidified. As a result, the inner wall of the insertion hole 15a and the lower end portions of the plurality of cells 1 are bonded and fixed, and the lower end portions of the cells 1 are bonded and fixed to each other. The gas-flow passages 2a of each of the cells 1 communicate, at the lower end portion, with the internal space 22 of the support member 14.

The fixing material 13 and the bonding material 21 may be one having a low electrical conductivity, such as glass. As the specific materials of the fixing material 13 and the bonding material 21, amorphous glass or the like may be used, and especially, crystallized glass or the like may be used.

As the crystallized glass, for example, any one selected from the group consisting of SiO₂—CaO-based, MgO—B₂O₃-based, La₂O₃—B₂O₃—MgO-based, La₂O₃—B₂O₃-ZnO-based, and SiO₂—CaO—ZnO-based materials may be used, or, in particular, an SiO₂-MgO-based material may be used.

As illustrated in FIG. 2B, a connecting member 18 is interposed between adjacent cells 1 of the plurality of cells 1. Each of the connecting members 18 electrically connects in series the fuel electrode 5 of one of adjacent ones of the cells 1 with the air electrode 8 of the other of the adjacent ones of the cells 1. More specifically, each of the connecting members 18 connects the interconnector 4 electrically connected to the fuel electrode 5 of the one of the adjacent ones of the cells 1 and the air electrode 8 of the other of the adjacent ones of the cells 1.

As illustrated in FIG. 2B, the end current collection members 17 are electrically connected to the cells 1 located at the outermost sides in the arrangement direction of the plurality of cells 1. The end current collection members 17 are each connected to an electrically conductive portion 19 protruding outward from the cell stack 11. The electrically conductive portion 19 collects electricity generated by the cells 1 and conducts the electricity to the outside. Note that in FIG. 2A, the end current collection members 17 are not illustrated.

As illustrated in FIG. 2C, the cell stack device 10 may be a single battery in which two cell stacks 11A and 11B are connected in series. In such a case, the electrically conductive portion 19 of the cell stack device 10 is divided into a positive electrode terminal 19A, a negative electrode terminal 19B, and a connection terminal 19C.

The positive electrode terminal 19A functions as a positive electrode when the electrical power generated by the cell stack 11 is output to the outside. The positive electrode terminal 19A is electrically connected to the end current collection member 17 on a positive electrode side in the cell stack 11A. The negative electrode terminal 19B functions as a negative electrode when the electrical power generated by the cell stack 11 is output to the outside. The negative electrode terminal 19B is electrically connected to the end current collection member 17 on a negative electrode side in the cell stack 11B.

The connection terminal 19C electrically connects the end current collection member 17 on the negative electrode side in the cell stack 11A and the end current collection member 17 on the positive electrode side in the cell stack 11B.

### Details of Solid Electrolyte Layer

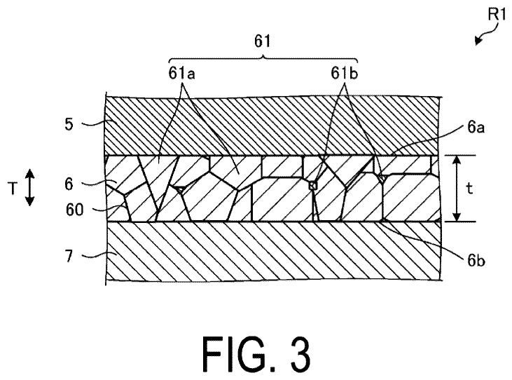

The solid electrolyte layer 6 included in the electrochemical cell according to the first embodiment will be described in detail with reference to FIG. 3. FIG. 3 is an enlarged cross-sectional view of the region R1 indicated in FIG. 1A.

As illustrated in FIG. 3, the solid electrolyte layer 6 has a first surface 6a and a second surface 6b located at opposite ends in the thickness direction T. The first surface 6a is in contact with the fuel electrode 5. The second surface 6b is in contact with the intermediate layer 7.

The solid electrolyte layer 6 includes a plurality of electrolytic particles 61. Each of the plurality of electrolytic particles 61 includes an oxide. The adjacent electrolytic particles 61 are partitioned by a grain boundary 60.

The plurality of electrolytic particles 61 include first particles 61a and second particles 61b. The first particles 61a are electrolytic particles 61 having a particle diameter of 1/10 or more of the average thickness of the solid electrolyte layer 6. The second particles 61b are electrolytic particles 61 having a particle diameter of less than 1/10 of the average thickness of the solid electrolyte layer 6. That is, when the average thickness of the solid electrolyte layer 6 is t, the first particles 61a have a particle diameter of not less than ( 1/10)t, and the second particles 61b have a particle diameter of less than ( 1/10)t. In other words, the second particles 61b are electrolytic particles 61 having a particle diameter smaller than that of the first particles 61a. Note that, the particle diameter of the electrolytic particles 61 is an equivalent circle diameter obtained by cross-sectional observation of the solid electrolyte layer 6. The average particle diameter of the second particles 61b may be ⅕ or less of the average particle diameter of the first particles 61a.

In the solid electrolyte layer 6, the plurality of electrolytic particles 61 include the first particles 61 a and the second particles 61b, and thus, for example, a gap is less likely to be generated between the adjacent electrolytic particles 61. As a result, a flexural strength of the solid electrolyte layer 6 is improved compared to, for example, the case where the plurality of electrolytic particles 61 do not include the second particles 61b. According to the cell 1 including the solid electrolyte layer 6, for example, the performance is improved.

In a cross section illustrated in FIG. 3, that is, in a cross section of the solid electrolyte layer 6 intersecting the first surface 6a and the second surface 6b, the solid electrolyte layer 6 may include the second particles 61b that are each in contact with two or more of the first particles 61a and surrounded by the two or more first particles 61a. As a result, for example, stress generated inside the solid electrolyte layer 6 is relaxed, and the flexural strength of the solid electrolyte layer 6 is further improved. According to the cell 1 including the solid electrolyte layer 6, for example, the performance is further improved. Hereinafter, the second particles 61b that are each in contact with two or more of the first particles 61a and are surrounded by the two or more first particles 61a are simply referred to as second particles 61b surrounded by two or more of the first particles 61a. The second particles 61b may be in contact with the first particles 61a via a grain boundary phase. In this case, the grain boundary phase may have a thickness not more than the particle diameter of the second particles 61b.

In the cross section illustrated in FIG. 3, the second particles 61b each surrounded by two or more first particles 61a may be two or less second particles 61b in contact with each other. As a result, for example, the movement of ions in the thickness direction T in an inner portion of the solid electrolyte layer 6 is less likely to be hindered, thereby ion conductivity is improved. According to the cell 1 including the solid electrolyte layer 6, for example, power generation capability is improved.

In the cross section of the solid electrolyte layer 6 illustrated in FIG. 3, one or more of the first particles 61a may be located between the first surface 6a and the second particles 61b. One or more of the first particles 61a may be located between the second surface 6b and the second particles 61b. In other words, the solid electrolyte layer 6 may include one or more first particles 61a between each of the first surface 6a and the second surface 6b, and the second particles 61a. The second particles 61b need not face the first surface 6a and the second surface 6b. As described above, the solid electrolyte layer 6 includes the second particles 61b located away from the first surface 6a and the second surface 6b. In the solid electrolyte layer 6, for example, compared with a case where the solid electrolyte layer 6 does not have the second particles 61b located away from the first surface 6a and the second surface 6b, stress generated in the inner portion of the solid electrolyte layer 6 is easily relaxed. As a result, the flexural strength of the solid electrolyte layer 6 is improved. According to the cell 1 including the solid electrolyte layer 6, for example, the performance is improved.

Among the plurality of electrolytic particles 61 included in the solid electrolyte layer 6, the second particles 61b located away from the first surface 6a and the second surface 6b may be present in a number ratio of not less than 90%. As described above, the solid electrolyte layer 6 has a large amount of the second particles 61b located away from the first surface 6a and the second surface 6b, and thus, for example, stress generated in the inner portion of the solid electrolyte layer 6 is easily relaxed, and the flexural strength of the solid electrolyte layer 6 is improved. According to the cell 1 including the solid electrolyte layer 6, for example, the performance is improved.

In the cross section illustrated in FIG. 3, the plurality of electrolytic particles 61 included in the solid electrolyte layer 6 may include the second particles 61b in a number ratio of not more than 20%. As a result, compared with a case where the plurality of electrolytic particles 61 include 20% or more second particles 61b, the movement of ions in the thickness direction T in the inner portion of the solid electrolyte layer 6 is less likely to be hindered, and ion conductivity is improved. According to the cell 1 including the solid electrolyte layer 6, for example, power generation capability is improved.

In the cross section illustrated in FIG. 3, the plurality of electrolytic particles 61 included in the solid electrolyte layer 6 may include the second particles 61b in a number ratio of 1% or more. As a result, in the solid electrolyte layer 6, for example, compared with a case where the plurality of electrolytic particles 61 include less than 1% of the second particles 61b, stress generated in the inner portion of the solid electrolyte layer 6 is easily relaxed, and the flexural strength of the solid electrolyte layer 6 is improved. According to the cell 1 including the solid electrolyte layer 6, for example, the performance is improved.

In the cross section illustrated in FIG. 3, the solid electrolyte layer 6 may have a porosity of 1% or less. As a result, for example, the movement of ions in the thickness direction T in the inner portion of the solid electrolyte layer 6 is less likely to be hindered, thereby ion conductivity is improved. According to the cell 1 including the solid electrolyte layer 6, for example, power generation capability is improved.

An average thickness t of the solid electrolyte layer 6 can be calculated using a cross-sectional photograph of the solid electrolyte layer 6. The arrangement and particle diameter of the plurality of electrolytic particles 61 included in the solid electrolyte layer 6 can be calculated based on the result of analysis using an electron-backscatter diffraction (EBSD) method in the cross section of the solid electrolyte layer 6 intersecting the first surface 6a and the second surface 6b. Specifically, a cross-section photograph of the solid electrolyte layer 6 is photographed by SEM, for example, at a magnification of 5000 times, and the obtained cross-section photograph is subjected to image analysis to calculate each of the particle diameters of the electrolytic particles 61 located in a region including 200 or more electrolytic particles 61 located between the first surface 6a and the second surface 6b. The particle diameter of each of the electrolytic particles 61 is a value obtained by measuring a surface area of the electrolytic particle 61 using, for example, image analysis software and converting the surface area into an equivalent circle diameter.

### Module

A module according to an embodiment of the present disclosure using the electrochemical cell device described above will be described with reference to FIG. 4. FIG. 4 is an exterior perspective view illustrating an example of a module according to the first embodiment. FIG. 4 illustrates a state in which the front and rear surfaces, which constitute part of a storage container 101, are removed, and the cell stack device 10 of the fuel cell stored inside is taken out rearward.

As illustrated in FIG. 4, the module 100 includes the storage container 101 and the cell stack device 10 stored in the storage container. The reformer 102 is disposed above the cell stack device 10.

The reformer 102 generates a fuel gas by reforming a raw fuel such as natural gas and kerosene and supplies the fuel gas to the cell 1. The raw fuel is supplied to the reformer 102 through a raw fuel supply pipe 103. Note that the reformer 102 may include a vaporizing unit 102a for vaporizing water and a reformer 102b. The reformer 102b includes a reforming catalyst (not illustrated) to reform the raw fuel into a fuel gas. The reformer 102 can perform steam-reforming, which is a highly efficient reformation reaction.

The fuel gas generated by the reformer 102 is supplied to the gas-flow passages 2a of the cell 1 (see FIG. 1A) through the gas circulation pipe 20, the gas tank 16, and the support member 14.

In the module 100 having the configuration mentioned above, the temperature in the module 100 during normal power generation is from about 500° C. to 1000° C. due to combustion of gas and power generation by the cell 1.

As described above, such a module 100 is configured to house the cell stack device 10 having the cell 1, whose performance is improved, so that the performance of the module 100 can be improved.

### Module Housing Device

FIG. 5 is an exploded perspective view schematically illustrating an example of a module housing device according to the first embodiment. A module housing device 110 according to the present embodiment includes an external case 111, the module 100 illustrated in FIG. 4, and an auxiliary device (not illustrated). The auxiliary device operates the module 100. The module 100 and the auxiliary device are housed in the external case 111. Note that part of the configuration is not illustrated in FIG. 5.

The external case 111 of the module housing device 110 illustrated in FIG. 5 includes a support 112 and an external plate 113. A dividing plate 114 vertically partitions the interior of the external case 111. The space above the dividing plate 114 in the external case 111 is a module housing chamber 115 for housing the module 100. The space below the dividing plate 114 in the external case 111 is an auxiliary device housing chamber 116 for housing the auxiliary device configured to operate the module 100. Note that, in FIG. 5, the auxiliary device housed in the auxiliary device housing chamber 116 is not illustrated.

The dividing plate 114 includes an air circulation hole 117 for causing air in the auxiliary device housing chamber 116 to flow to the module housing chamber 115 side. The external plate 113 constituting the module housing chamber 115 has an exhaust hole 118 for discharging air inside the module housing chamber 115.

In such a module housing device 110, as described above, the module 100 with the improved performance is provided in the module housing chamber 115, thus providing the module housing device 110 with the improved performance.

Note that, in the embodiment described above, the case in which the support substrate having the hollow flat plate shape is used has been exemplified, but the embodiment can also be applied to a cell stack device using a cylindrical support substrate.

### Second Embodiment

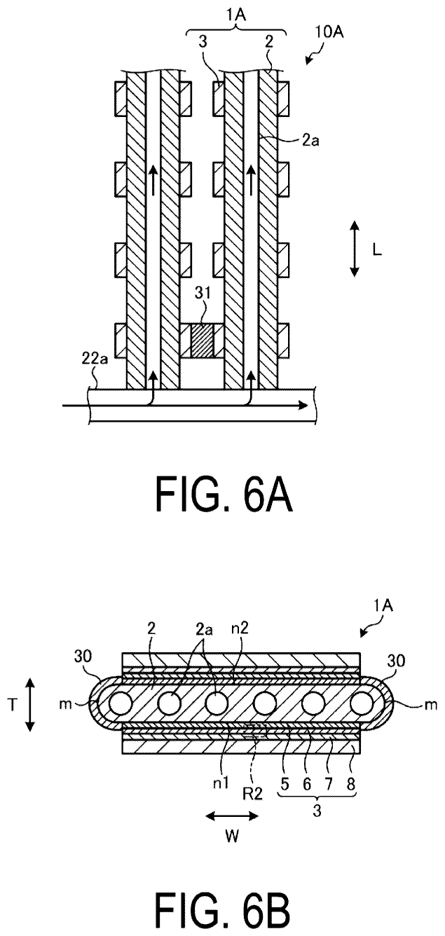

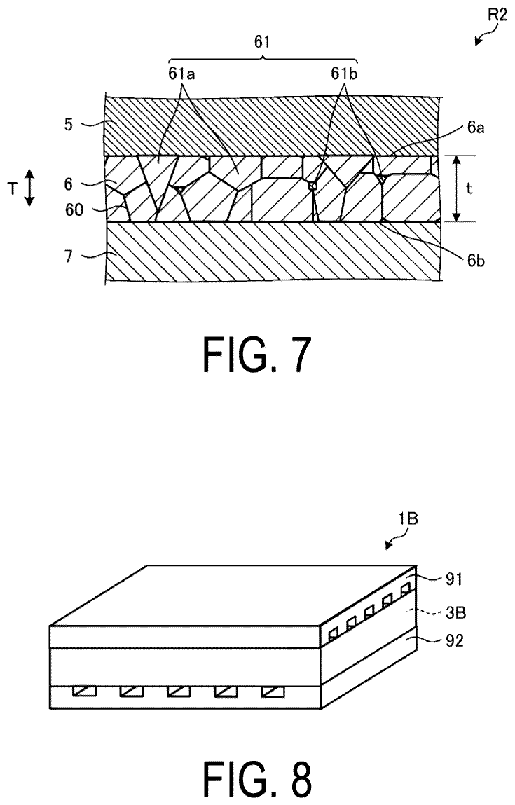

Next, an electrochemical cell and an electrochemical cell device according to a second embodiment will be described with reference to FIGS. 6A to 7.

In the embodiment described above, a so-called “vertically striped type” cell stack device, in which only one element portion including a fuel electrode, a solid electrolyte layer, and an air electrode is provided on the surface of the support substrate, is exemplified. However, the present disclosure can be applied to a horizontally striped type electrochemical cell device with an array of so-called “horizontally striped type” electrochemical cells, in which a plurality of element portions are provided on the surface of a support substrate at mutually separated locations and adjacent element portions are electrically connected to each other.

FIG. 6A is a cross-sectional view illustrating an example of an electrochemical cell device according to a second embodiment. FIG. 6B is a horizontal cross-sectional view illustrating an example of an electrochemical cell according to the second embodiment. FIG. 7 is an enlarged cross-sectional view of the region R2 indicated in FIG. 6B.

As illustrated in FIG. 6A, a cell stack device 10A includes a plurality of cells 1A extending in the length direction L from a pipe 22a that distributes a fuel gas. Each of the cells 1A includes a plurality of the element portions 3 on the support substrate 2. A gas-flow passage 2a, through which a fuel gas from the pipe 22a flows, is provided inside the support substrate 2.

The cells 1A are electrically connected to each other via connecting members 31. Each of the connecting members 31 is located between the element portions 3 each included in a corresponding one of the cells 1A and electrically connects adjacent ones of the cells 1A to each other.

As illustrated in FIG. 6B, the cell 1A according to the second embodiment includes the support substrate 2, a pair of the element portions 3, and a sealing portion 30. The support substrate 2 has a pillar shape including a first flat surface n1 and a second flat surface n2, which are a pair of flat surfaces facing each other, and a pair of circular arc-shaped side surfaces m that connect the first flat surface n1 and the second flat surface n2.

The pair of element portions 3 are located on the first flat surface n1 and the second flat surface n2 of the support substrate 2 so as to face each other. The sealing portion 30 is located to cover the side surfaces m of the support substrate 2.

As illustrated in FIG. 7, the solid electrolyte layer 6 includes the first surface 6a and the second surface 6b located at opposite ends in the thickness direction T. The first surface 6a is in contact with the fuel electrode 5. The second surface 6b is in contact with the intermediate layer 7.

The solid electrolyte layer 6 includes the plurality of electrolytic particles 61 delimited by grain boundaries 60. Each of the plurality of electrolytic particles 61 includes an oxide.

The plurality of electrolytic particles 61 include first particles 61a and second particles 61b. The first particles 61a are electrolytic particles 61 having a particle diameter of 1/10 or more of the average thickness of the solid electrolyte layer 6. The second particles 61b are electrolytic particles 61 having a particle diameter smaller than that of the first particles 61a. That is, when the average thickness of the solid electrolyte layer 6 is t, the first particles 61a have a particle diameter of not less than ( 1/10)t, and the second particles 61b have a particle diameter of less than ( 1/10)t.

In the solid electrolyte layer 6, the plurality of electrolytic particles 61 include the first particles 61a and the second particles 61b, and thus, for example, a gap is less likely to be generated between the adjacent electrolytic particles 61. As a result, the flexural strength of the solid electrolyte layer 6 is improved compared with, for example, the case where the plurality of electrolytic particles 61 do not include the second particles 61b. According to the cell 1A including the solid electrolyte layer 6, for example, the performance is improved.

### Third Embodiment

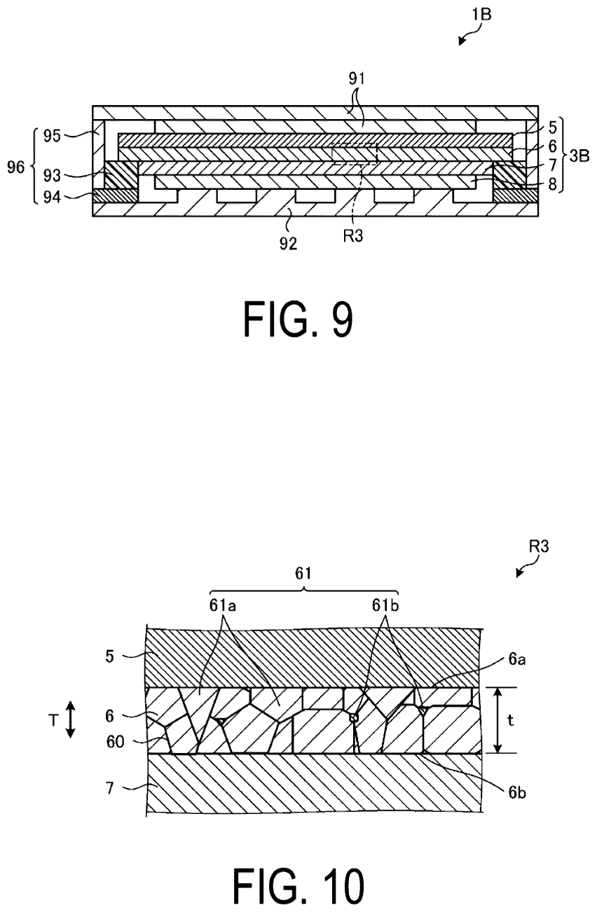

FIG. 8A is a perspective view illustrating an example of an electrochemical cell according to a third embodiment. FIG. 9 is a partial cross-sectional view illustrating an example of the electrochemical cell illustrated in FIG. 8.

As illustrated in FIGS. 8 and 9, a cell 1B includes an element portion 3B in which the fuel electrode 5, the solid electrolyte layer 6, the intermediate layer 7, and the air electrode 8 are stacked, and conductive members 91, 92. In an electrochemical cell device in which a plurality of flat plate cells are layered, for example, a plurality of cells 1B are electrically connected by electrically conductive members 91 and 92 that are metal layers adjacent to each other. The electrically conductive members 91 and 92 electrically connect adjacent ones of the cells 1B to each other, and each include gas-flow passages for supplying gas to the fuel electrode 5 or the air electrode 8.

As illustrated in FIG. 9, the cell 1B includes a sealing material for hermetically sealing the flow passage of a fuel gas and the flow passage of an oxygen-containing gas in the flat plate cell stack. The sealing material is a fixing member 96 of the cell, and includes a bonding material 93 and support members 94 and 95 constituting a frame. The bonding material 93 may be a glass or may be a metal material such as silver solder.

The support member 94 may be a so-called separator that separates the flow passage of the fuel gas and the flow passage of the oxygen-containing gas. The material of the support members 94 and 95 may be, for example, an electrically conductive metal, or may be an insulating ceramic. One or both of the support members 94 and 95 may be an insulating material. When the support member 94 is a metal, the support member 94 may be integrated with the electrically conductive member 92. When the support member 95 is a metal, the support member 95 may be integrated with the electrically conductive member 91.

One of the support members 94 and 95 has insulation properties and electrically insulates the two electrically conductive members 91 and 92, which sandwich the flat-plate cell, from each other.

FIG. 10 is an enlarged cross-sectional view of a region R3 illustrated in FIG. 9. As illustrated in FIG. 10, the solid electrolyte layer 6 includes the first surface 6a and the second surface 6b located at opposite ends in the thickness direction T. The first surface 6a is in contact with the fuel electrode 5. The second surface 6b is in contact with the intermediate layer 7.

The solid electrolyte layer 6 includes the plurality of electrolytic particles 61 delimited by grain boundaries 60. Each of the plurality of electrolytic particles 61 includes an oxide.

The plurality of electrolytic particles 61 include first particles 61a and second particles 61b. The first particles 61a are electrolytic particles 61 having a particle diameter of 1/10 or more of the average thickness of the solid electrolyte layer 6. The second particles 61b are electrolytic particles 61 having a particle diameter smaller than that of the first particles 61a. That is, when the average thickness of the solid electrolyte layer 6 is t, the first particles 61a have a particle diameter of not less than ( 1/10)t, and the second particles 61b have a particle diameter of less than ( 1/10)t.

In the solid electrolyte layer 6, the plurality of electrolytic particles 61 include the first particles 61a and the second particles 61b, and thus, for example, a gap is less likely to be generated between the adjacent electrolytic particles 61. As a result, the flexural strength of the solid electrolyte layer 6 is improved compared with, for example, the case where the plurality of electrolytic particles 61 do not include the second particles 61b. According to the cell 1B including the solid electrolyte layer 6, for example, the performance is improved.

### Fourth Embodiment

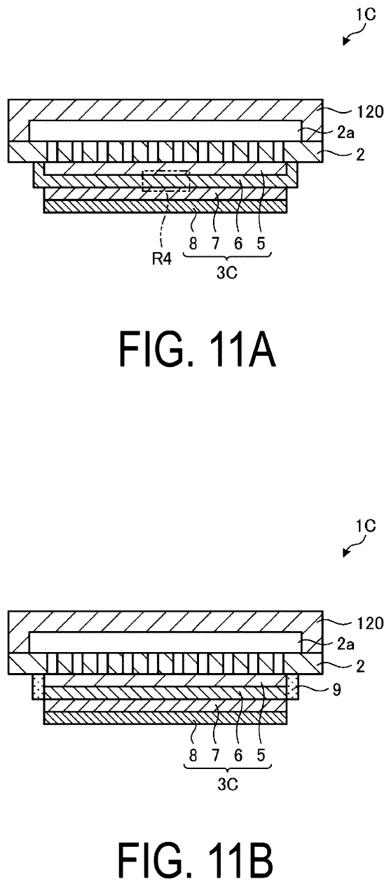

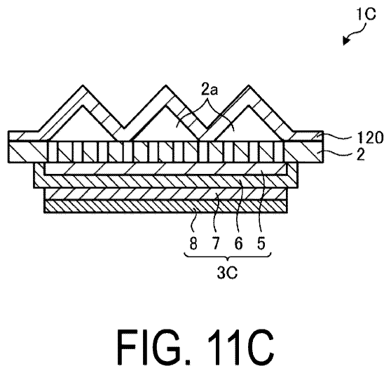

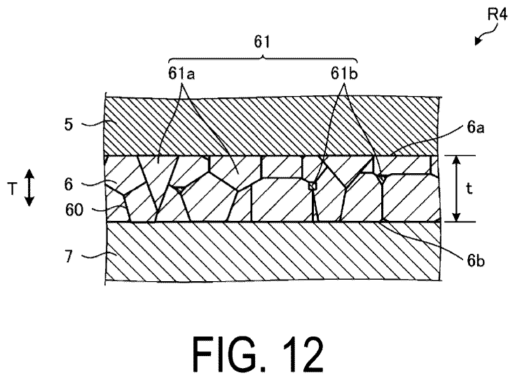

FIG. 11A is a horizontal cross-sectional view illustrating an example of an electrochemical cell according to a fourth embodiment. FIGS. 11B and 11C are horizontal cross-sectional views illustrating other examples of the electrochemical cell according to the fourth embodiment. FIG. 12 is an enlarged view of the region R4 illustrated in FIG. 11A. Note that FIG. 12 can also be applied to the examples of FIGS. 11B and 11C.

As illustrated in FIGS. 11A to 11C, a cell 1C includes an element portion 3C in which the fuel electrode 5, the solid electrolyte layer 6, the intermediate layer 7, and the air electrode 8 are layered, and the support substrate 2. The support substrate 2 includes through holes or fine holes at a site in contact with the element portion 3C, and includes a member 120 located outside the gas-flow passage 2a. The support substrate 2 allows gas to flow between the gas-flow passage 2a and the element portion 3C. The support substrate 2 may be made of, for example, one or more metal plates. A material of the metal plate may contain chromium. The metal plate may include an electrically conductive coating layer. The support substrate 2 electrically connects adjacent ones of the cells 1C to each other. The element portion 3C may be directly formed on the support substrate 2 or may be bonded to the support substrate 2 with a bonding material.

In the example illustrated in FIG. 11A, the side surface of the fuel electrode 5 is covered with the solid electrolyte layer 6 to hermetically seal the gas-flow passage 2a through which the fuel gas flows. As illustrated in FIG. 11B, the side surface of the fuel electrode 5 may be covered and sealed with a sealing material 9 of dense glass or ceramic. The sealing material 9 coating the side surface of the fuel electrode 5 may have electrical insulation properties.

The gas-flow passage 2a of the support substrate 2 may be made of the member 120 having unevenness as illustrated in FIG. 11C.

As illustrated in FIG. 12, the solid electrolyte layer 6 includes the first surface 6a and the second surface 6b located at opposite ends in the thickness direction T. The first surface 6a is in contact with the fuel electrode 5. The second surface 6b is in contact with the intermediate layer 7.

The solid electrolyte layer 6 includes the plurality of electrolytic particles 61 delimited by grain boundaries 60. Each of the plurality of electrolytic particles 61 includes an oxide.

The plurality of electrolytic particles 61 include first particles 61a and second particles 61b. The first particles 61a are electrolytic particles 61 having a particle diameter of 1/10 or more of the average thickness of the solid electrolyte layer 6. The second particles 61b are electrolytic particles 61 having a particle diameter smaller than that of the first particles 61a. That is, when the average thickness of the solid electrolyte layer 6 is t, the first particles 61a have a particle diameter of not less than ( 1/10)t, and the second particles 61b have a particle diameter of less than ( 1/10)t.

In the solid electrolyte layer 6, the plurality of electrolytic particles 61 include the first particles 61a and the second particles 61b, and thus, for example, a gap is less likely to be generated between the adjacent electrolytic particles 61. As a result, the flexural strength of the solid electrolyte layer 6 is improved compared with, for example, the case where the plurality of electrolytic particles 61 do not include the second particles 61b. According to the cell 1C including the solid electrolyte layer 6, for example, the performance is improved.

### Other Embodiments

An electrochemical cell device according to other embodiments will be described.

In the above-described embodiments, the solid oxide fuel cell, the fuel cell stack device, the fuel cell module, and the fuel cell device have been described as examples of the “electrochemical cell”, the “electrochemical cell device”, the “module”, and the “module housing device”. However, as other examples, a solid oxide electrolysis cell, an electrolysis cell stack device, an electrolysis module, and an electrolysis device may be used. The electrolytic cell includes a first electrode and a second electrode and, when being supplied with electrical power, decomposes water vapor into hydrogen and oxygen or decomposes carbon dioxide into carbon monoxide and oxygen. Although an oxide ion conductor or a hydrogen ion conductor is illustrated as an example of the electrolyte material of the electrochemical cell in each of the above embodiments, the electrolyte material may be a hydroxide ion conductor. According to the electrolysis cell, the electrolysis cell stack device, the electrolysis module, and the electrolysis device, performance can be improved.

### EXAMPLE

Samples Nos. 1 to 8 simulating the solid electrolyte layer 6 were prepared, and their performance was evaluated.

### Preparation of Samples Nos. 1 to 8

Samples Nos. 1 to 8 were prepared using particulate electrolyte materials having different particle diameters. As electrolyte materials having different particle diameters, two kinds of ZrO₂ materials (YSZ materials) with 8 mole % of Y₂O₃ in solid solution were prepared. The two kinds of YSZ materials are a material A having an average particle diameter of 2 μm and a material B having an average particle diameter of 0.5 μm. Two kinds of slurries were prepared using the material A, the material B, a solvent, and a dispersant. A slurry A was obtained by deflocculating the material A together with a solvent and a dispersant in a ball mill for 10 hours. A slurry B was obtained by deflocculating the material B together with a solvent and a dispersant in a ball mill for 0.5 hours. The deflocculating time of the slurry B was shortened so that some of the particles were left agglomerated. The agglomerated particles of the material B are hardly absorbed by the particles of the material A even when the particles of the material B are mixed with the material A and fired, and are likely to remain as the second particles 61b in the solid electrolyte layer 6.

The slurry A and the slurry B were mixed at ratios as follows and dried to obtain mixed powders. The mixing ratio of the slurry A and the slurry B was set as follows: Samples Nos. 1 and 5 (100:0), Samples Nos. 2 and 6 (98:2), Samples Nos. 3 and 7 (97:3), and Samples Nos. 4 and 8 (95:5) in terms of a mass ratio (A: B) of the material A and the material B.

Test pieces (Samples Nos. 1 to 4) for a flexural strength test were prepared using the prepared mixed powder. The mixed powder was uniaxially compression-molded to produce rectangular parallelepiped compacts. The obtained powder compacts were fired at 1500° C. in the atmosphere to produce sintered bodies having different content ratios of the second particles 61b.

Each of the single cells (Samples Nos. 5 to 8) was produced by forming the solid electrolyte layer 6 using the mixed powder, the fuel electrode 5, the intermediate layer 7, and the air electrode 8, and the resistance of the solid electrolyte layer 6 was evaluated as the resistance of the single cell. A laminated sintered body was obtained by degreasing and then firing at 1500° C. a laminated sheet formed by layering solid electrolyte layer sheets prepared using the mixed powder described above onto a molding sheet for a fuel electrode. The slurry for the intermediate layer was applied onto the solid electrolyte layer of the obtained laminated sintered body, degreased, and then fired at 1350° C. in the atmosphere. The slurry for the air electrode was further applied onto the formed intermediate layer, degreased, and then fired at 1150° C. in the atmosphere to obtain a single cell including the solid electrolyte layer 6 with a different content ratio of the second particles 61b.

### Evaluation of Samples Nos. 1 to 4

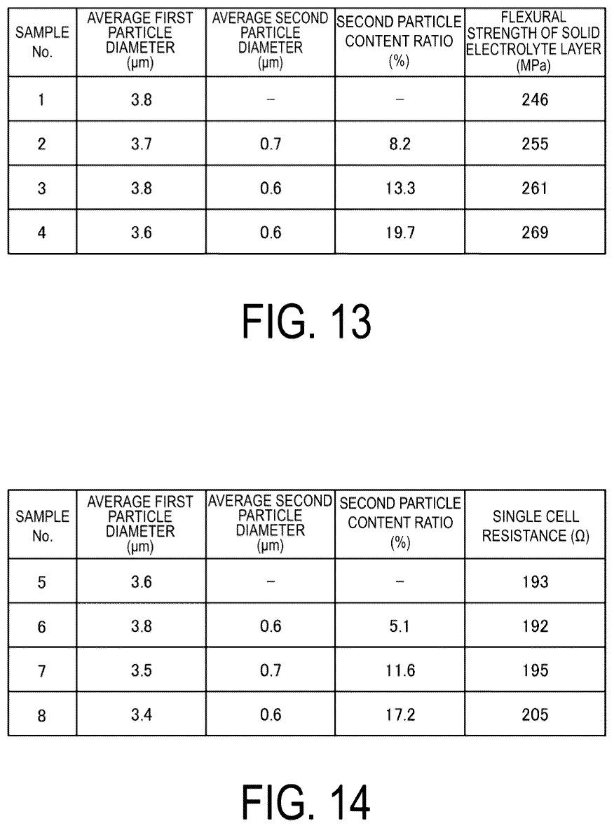

For each of Samples Nos. 1 to 4, the average particle diameter of the first particles 61a, the average particle diameter of the second particles 61b, the content ratio of the second particles 61b, and the flexural strength of the solid electrolyte layer 6 were measured. FIG. 13 is a diagram showing evaluation results of Samples Nos. 1 to 4. In FIG. 13, the content ratio of the second particles 61b is the number ratio of the second particles 61b among the electrolytic particles 61 in each of Samples Nos. 1 to 4 in which the cross section was observed. The flexural strength is a four-point bending strength measured in accordance with JIS R 1601.

As shown in FIG. 13, in Samples Nos. 2 to 4 including the first particles 61a and the second particles 61b, the flexural strength was higher than that of Sample No. 1 including only the first particles 61a. In Samples Nos. 2 to 4, when the content ratio of the second particles 61b was increased, the flexural strength increased accordingly.

### Evaluation of Samples Nos. 5 to 8

For each of Samples Nos. 5 to 8, the average particle diameter of the first particles 61a, the average particle diameter of the second particles 61b, the content ratio of the second particles 61b, and the resistance of the single cell included in the solid electrolyte layer 6 were measured. FIG. 14 is a diagram showing evaluation results of Samples Nos. 5 to 8. In FIG. 14, the content ratio of the second particles 61b is the number ratio of the second particles 61b among the number of the electrolytic particles 61 in the solid electrolyte layer 6 of each of Samples Nos. 5 to 8 in which the cross section was observed. The resistance is ohmic resistance measured by an AC impedance method.

As shown in FIG. 14, in Samples Nos. 6 to 8 including the first particles 61a and the second particles 61b, the resistance increased as the content ratio of the second particles 61b increased. Samples Nos. 6 and 7 had a resistance equivalent to that of Sample No. 5 having only the first particles 61a. In Sample No. 8, the resistance increased as compared with Sample No. 5, but the increase was at a level that did not cause a problem in actual use.

While the present disclosure has been described in detail, the present disclosure is not limited to the aforementioned embodiments, and various changes, improvements, and the like can be made without departing from the gist of the present disclosure.

In one embodiment, (1) the solid electrolyte layer is a solid electrolyte layer including a plurality of electrolytic particles containing an oxide. The plurality of electrolytic particles include first particles having a particle diameter of 1/10 or more of an average thickness of the solid electrolyte layer and second particles having a particle diameter smaller than that of the first particles.

(2) The solid electrolyte layer according to (1), may further include a first surface and a second surface located at opposite ends in a thickness direction. In a cross section intersecting the first surface and the second surface, the solid electrolyte layer may include the second particles that are in contact with two or more of the first particles and surrounded by the two or more first particles.

(3) In the solid electrolyte layer according to (2) above, in the cross section intersecting the first surface and the second surface, the two or more first particles may surround not more than two of the surrounded second particles that are in contact with each other.

(4) The solid electrolyte layer of any one of (1) to (3) above, may include a first surface and a second surface located at opposite ends in a thickness direction. In the cross section intersecting the first surface and the second surface, the one or more first particles may be located between each of the first surface and the second surface, and the second surface.

(5) The solid electrolyte layer of any one of (1) to (4) above, may include a first surface and a second surface located at opposite ends in the thickness direction. In the cross section intersecting the first surface and the second surface, the plurality of electrolytic particles may include the second particles in a number ratio of 20% or less.

(6) The solid electrolyte layer according to any one of (1) to (5), may include a first surface and a second surface located at opposite ends in the thickness direction In the cross section intersecting the first surface and the second surface, a porosity may be 1% or less.

In one embodiment, (7) an electrochemical cell includes the solid electrolyte layer according to any one of (1) to (6).

In one embodiment, (8) an electrochemical cell device includes a cell stack including the electrochemical cell of (7) above.

In one embodiment, (9) a module includes: the electrochemical cell device of (8) above, and a storage container housing the electrochemical cell device.

In one embodiment, (10) a module housing device includes: the module of (9) above, an auxiliary device that operates the module, and an external case housing the module and the auxiliary device.

The embodiments disclosed herein should be considered exemplary in all respects and not restrictive. Indeed, the embodiments described above may be embodied in various forms. The embodiments described above may also be omitted, replaced, or modified in various forms without departing from the scope and spirit of the attached claims.

### Reference Signs

1, 1A to 1C Cell
2 Support substrate
3 Element portion
4 Interconnector
5 Fuel electrode
6 Solid electrolyte layer
7 Intermediate layer
8 Air electrode
10 Cell stack device
11 Cell stack
12 Fixing member
13 Fixing material
14 Support member
15 Support body
16 Gas tank
17 End current collection member
18 Connecting member
60 Grain boundary
61 Electrolytic particle
61a First particle
61b Second particle
100 Module
110 Module housing device

1. A solid electrolyte layer comprising:
a plurality of electrolytic particles containing an oxide, wherein,
the plurality of electrolytic particles comprise:
first particles having a particle diameter of 1/10 or more of an average thickness of the solid electrolyte layer; and
second particles having a particle diameter smaller than that of the first particles.

2. The solid electrolyte layer according to claim 1, comprising:
a first surface and a second surface located at opposite ends in a thickness direction, wherein,
in a cross section intersecting the first surface and the second surface, the solid electrolyte layer comprises the second particles that are each in contact with two or more of the first particles and surrounded by the two or more of the first particles.

3. The solid electrolyte layer according to claim 2, wherein,
in the cross section intersecting the first surface and the second surface, the two or more first particles surround not more than two of the surrounded second particles that are in contact with each other.

4. The solid electrolyte layer according to claim 1, comprising:
a first surface and a second surface located at opposite ends in a thickness direction, wherein,
in a cross section intersecting the first surface and the second surface, one or more of the first particles are located between each of the first surface and the second surface, and the second particles.

5. The solid electrolyte layer according to claim 1, any comprising:
a first surface and a second surface located at opposite ends in a thickness direction, wherein,
in a cross section intersecting the first surface and the second surface, the plurality of electrolytic particles comprise the second particles in a number ratio of 20% or less.

6. The solid electrolyte layer according to claim 1, comprising:
a first surface and a second surface located at opposite ends in a thickness direction, wherein,
in a cross section intersecting the first surface and the second surface, a porosity is 1% or less.

7. An electrochemical cell comprising:
the solid electrolyte layer according to claim 1.

8. An electrochemical cell device comprising:
a cell stack comprising:
the electrochemical cell according to claim 7.

9. A module comprising:
the electrochemical cell device according to claim 8; and
a storage container configured to house the electrochemical cell device.

10. A module housing device comprising:
the module according to claim 9;
an auxiliary device configured to operate the module; and
an external case configured to house the module and the auxiliary device.
